(19) United States
(12) Patent Application Publication
(10) Pub. No.: US 2006/0232102 A1
(43) Pub. Date: Oct. 19, 2006

(54) Truck streamlining

(76) Inventor: Kenneth Steel, Dunedin (NZ)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/107,762

(22) Filed: Apr. 15, 2005

(51) Int. Cl. B62D 35/00

(52) U.S. Cl. 296/180.1

(57) ABSTRACT

A leading edge airfoil 7, intermediate airfoil 9 and trailing edge airfoil 11 are provided to reduce drag on a truck towing or carrying at least one bluff body as a load. The leading edge airfoil 7 has a curved nose 23 and an upper surface angled away from the curved nose, and may have a rear part of the upper surface substantially aligned with an upper surface of the most forward bluff body, to assist in attaching oncoming airflow to the upper surface of the most forward bluff body. The intermediate airfoil is configured in use to direct airflow over the gap between two bluff bodies and toward the upper surface of the most rearward of the two bluff bodies. The trailing edge airfoil is configured to reduce the area and volume of the load's turbulent flow in use. The airfoils may be provided individually or as a set.

### FIELD OF THE INVENTION

This invention relates to aerodynamic devices to assist in reducing drag and streamlining vehicles, and more particularly to assist in reducing drag on trucks having a tractor unit and one or more trailer units. However, the aerodynamic devices are not limited to this use, and may be used to assist in reducing drag on other moving bluff bodies, such as trucks with tray-mounted containers.

### BACKGROUND

Rising fuel costs and the need for increased profit margins are two of the reasons why commercial heavy vehicle operators need to address the aerodynamics of their fleet. High bodied vehicles such as trucks having a tractor unit with an “A” train (the trailer immediately behind the tractor unit) and optionally a “B” train (the trailer behind the “A” train), such as curtain-siders or container transporters, present bluff bodies to oncoming air flow. These bluff bodies create significant air drag, and at increased road speeds and distances over which these loads are hauled, an increased proportion of the tractor unit's energy output is expended on overcoming air drag, resulting in increased fuel consumption and associated running costs.

Attempts have been made at addressing this air drag and reducing the associated fuel costs, in the form of deflectors mounted on the top of the tractor unit roof. These deflectors simply deflect the current of moving air up and away from the load attached to the tractor unit, and provide only a limited reduction in air drag and fuel costs. The degree of drag reduction with head on air flow to the tractor unit offered by these fittings mounted to the tractor unit varies from 11% for a straight roof-mounted sheet deflector to 30% for a full load height contoured and waisted model. Further, it has been found that some deflectors actually increase the air drag.

Another type of known deflector is in the form of a curved body protruding from the front of an “A” train trailer or other bluff body. Again, such a device deflects the air over the top of the trailer, and provides only limited benefits. Typical drag reduction for one of these deflectors is in the order of 5.5%. Further, such a device is generally only used on the front wall of a curtain-sider trailer, and is permanently attached. Due to the permanent attachment, the devices are not generally used with containers.

Both of the above conventional devices simply act as deflectors, and do not address the flow regimes imparted to the vehicle and/or its load when in motion.

It is an object of the present invention to provide aerodynamic devices to assist in reducing drag which address at least one of the abovementioned limitations and/or which at least provides the public with a useful choice.

### SUMMARY OF THE INVENTION

In accordance with a first aspect of the present invention, there is provided a leading edge airfoil for reducing drag on a truck towing or carrying at least one bluff body as a load, the airfoil comprising a curved nose and an upper surface angled away from the curved nose and a lower surface extending rearwardly from the curved nose, with the vertical distance from a lowest point of the lower surface to a most forward part of the curved nose being less than the vertical distance from an upper point of the upper surface to the most forward part of the curved nose, the airfoil configured for attachment to a most forward bluff body of the load or to the top of a tractor unit with a rear part of the upper surface substantially aligned with an upper surface of the most forward bluff body of the load and with a space provided below the lower surface of the airfoil, such that the airfoil assists in attaching oncoming airflow to the upper surface of the most forward bluff body, thereby reducing air drag.

An airfoil generates lift through a combination of the pressure difference between upper and lower surfaces, and its angle of attack, which is the relative angle of the airfoil to the oncoming airflow. An airfoil may have a positive, negative or zero angle of attack.

The airfoil is preferably configured for attachment to a forward surface of the most forward bluff body.

The airfoil is suitably configured to produce lift and laminar flow, thereby assisting in attaching oncoming airflow to the upper surface of the bluff body in use.

Preferably, the airfoil has a span defined by a width of the airfoil and a chord defined by the distance from the most forward part of the nose to a trailing edge, and the ratio of airfoil span to airfoil chord is between about 7:1 and about 9:1.

Preferably, the airfoil has a chord defined by the distance from the most forward part of the nose to a trailing edge and a maximum thickness defined by the maximum distance between the upper surface and the lower surface, and the ratio of airfoil chord to maximum airfoil thickness is between about 1.1:1 and about 1.4:1.

The lower surface is preferably angled away from the curved nose. Preferably, the upper surface generally extends rearwardly from the nose with a greater angle than the lower surface. Preferably, the airfoil has a maximum thickness defined by the maximum distance between the upper surface and the lower surface, and the vertical distance from the lowest point of the lower surface to the most forward part of the curved nose is between about 22% and 33% of the maximum thickness.

Preferably, the airfoil has a chord defined by the distance from the most forward part of the nose to a trailing edge and the radius of the nose is about 40% of the airfoil chord.

The airfoil suitably comprises end plates or fins extending upwardly from respective ends of the airfoil, which end plates or fins are arranged to assist in entraining air flow over the airfoil in use. The end plates or fins may extend rearwardly and above an upper rear edge of the airfoil.

The airfoil preferably comprises an attachment arrangement for attaching the airfoil to the most forward bluff body. The attachment arrangement suitably comprises flanges configured to engage one or more surfaces of the most forward bluff body.

Alternatively, the attachment arrangement is configured to engage twist lock or cam lock sockets on a container. The attachment arrangement comprises spaced apart twist lock or cam lock pins configured for receipt in the twist lock or cam lock sockets. Alternatively, the attachment arrangement comprises substantially J-shaped connectors configured for receipt in complementary twist lock or cam lock sockets in the container and configured such that the airfoil must be tilted to remove it from the container.

In accordance with a second aspect of the present invention, there is provided a set of airfoils for reducing drag on a truck towing or carrying at least one bluff body as a load, comprising a leading edge airfoil as outlined in the first aspect above and a trailing edge airfoil which is configured for attachment at or adjacent a trailing edge of a most rearward bluff body of the load, and which is configured to reduce the area and volume of the load's turbulent flow in use, thereby reducing air drag.

The trailing edge airfoil preferably has a central portion with a curved leading edge and a relatively sharp trailing edge.

Preferably, the trailing edge airfoil has a span defined by a width of the trailing edge airfoil and a chord defined by the distance from the leading edge of the trailing edge airfoil to the trailing edge of the trailing edge airfoil, and the ratio of airfoil span of the trailing edge airfoil to airfoil chord of the trailing edge airfoil is between about 3.75:1 and about 4.25:1. The ratio of airfoil span of the trailing edge airfoil to airfoil chord of the trailing edge airfoil may be about 4.1:1.

Preferably, the trailing edge airfoil has a chord defined by the distance from the leading edge of the trailing edge airfoil to the trailing edge of the trailing edge airfoil and a maximum thickness defined by the maximum distance between an upper surface of the trailing edge airfoil and a lower surface of the trailing edge airfoil, and the size of the maximum thickness of the trailing edge airfoil is preferably between about 8.1% and about 13.5% of the size of the chord of the trailing edge airfoil. The size of the maximum thickness of the trailing edge airfoil is preferably about 13.2% of the size of the chord of the trailing edge airfoil.

Preferably, the trailing edge airfoil has a maximum thickness defined by the maximum distance between an upper surface of the trailing edge airfoil and a lower surface of the trailing edge airfoil, and the vertical distance from the lowest point of the lower surface of the trailing edge airfoil to a forward most portion of the curved leading edge of the trailing edge airfoil is between about 35% and 40% of the maximum airfoil thickness of the trailing edge airfoil.

Advantageously, the trailing edge airfoil has a maximum thickness defined by the maximum distance between an upper surface of the trailing edge airfoil and a lower surface of the trailing edge airfoil, and the radius of the curved leading edge of the trailing edge airfoil is between about 30% and about 35% of the maximum thickness of the trailing edge airfoil. The radius of the curved leading edge of the trailing edge airfoil may be about 33.3% of the maximum thickness of the trailing edge airfoil.

The trailing edge airfoil preferably comprises at least one vortex generating projection to induce a rearward vortex in use. More preferably, the trailing edge airfoil comprises a pair of vortex generating tips at the ends of the airfoil.

Preferably the tips of the trailing edge airfoil extend rearwardly, and are arranged so that in use two vortices of opposite sense are generated, confining drag to a smaller area. The tips of the trailing edge airfoil may be arranged so that in use, as the vortices travel rearwardly they enlarge in diameter and impinge on each other, pulling turbulent airstream which is exiting from the underside of the vehicle into a substantially constant flow regime.

The tips of the trailing edge airfoil preferably extend upwardly when the trailing edge airfoil is attached to the bluff body.

Preferably, the trailing edge airfoil has a chord defined by the distance from a leading edge of the trailing edge airfoil to a trailing edge of the trailing edge airfoil, and the tips extend rearwardly of the trailing edge of the trailing edge airfoil by about 25% of the chord of the trailing edge airfoil.

Preferably, the trailing edge airfoil has a maximum thickness defined by the maximum distance between an upper surface of the trailing edge airfoil and a lower surface of the trailing edge airfoil, and the rise of each tip directly above the point of maximum thickness of the trailing edge airfoil is about 14% of the maximum thickness of the trailing edge airfoil.

In a preferred embodiment, the trailing edge airfoil has a point of maximum lift, and the trailing edge airfoil is configured for attachment to the most rearward bluff body so that its point of maximum lift is located substantially directly above the trailing edge of the bluff body, and so that a gap is provided between a lower surface of the trailing edge airfoil and the trailing edge of the bluff body.

The trailing edge airfoil is preferably configured for attachment at or adjacent the trailing edge of the most rearward bluff body of the load with a positive angle of attack relative to oncoming airflow, to downwardly direct oncoming airflow.

The trailing edge airfoil suitably includes an attachment arrangement for attaching the trailing edge airfoil at or adjacent the trailing edge of the most rearward bluff body of the load. The attachment arrangement for attaching the trailing edge airfoil may comprise flanges configured to engage one or more surfaces of the most rearward bluff body.

Alternatively, the attachment arrangement for attaching the trailing edge airfoil may be configured to engage twist lock or cam lock sockets on a container. The attachment arrangement for attaching the trailing edge airfoil advantageously comprises spaced apart twist lock or cam lock pins configured for receipt in the twist lock or cam lock sockets. Alternatively, the attachment arrangement for attaching the trailing edge airfoil may comprise substantially J-shaped connectors configured for receipt in complementary twist lock or cam lock sockets in the container and configured such that the trailing edge airfoil must be tilted to remove it from the container.

In accordance with a third aspect of the present invention, there is provided a set of airfoils as outlined in the second aspect above for reducing drag on a truck towing or carrying at least two bluff bodies as a load, comprising an intermediate airfoil which is configured for attachment at or adjacent an upper trailing edge of the most forward of the bluff bodies of the load, and which is configured in use to direct airflow over the gap between the most forward bluff body and a following bluff body and toward the upper surface of the following bluff body in use, thereby reducing air drag.

The intermediate airfoil may have a central portion with a curved leading edge and a relatively sharp trailing edge.

Preferably, the intermediate airfoil has a span defined by a width of the intermediate airfoil and a chord defined by the distance from the leading edge of the intermediate airfoil and the trailing edge of the intermediate airfoil, and the ratio of airfoil span of the intermediate airfoil to airfoil chord of the intermediate airfoil is between about 5.5:1 and about 6:1. The ratio of airfoil span of the intermediate airfoil to airfoil chord of the intermediate airfoil may be about 5.8:1.

Preferably, the intermediate airfoil has a chord defined by the distance from the leading edge of the intermediate airfoil to the trailing edge of the intermediate airfoil and a maximum thickness defined by the maximum distance between an upper surface of the intermediate airfoil and a lower surface of the intermediate airfoil, and the size of the maximum thickness of the intermediate airfoil is between about 8.1% and 13.5% of the size of the chord of the intermediate airfoil. The size of the maximum thickness of the intermediate airfoil is preferably about 13% of the size of the chord of the intermediate airfoil.

In a preferred embodiment, the intermediate airfoil has a maximum thickness defined by the maximum distance between an upper surface of the intermediate airfoil and a lower surface of the intermediate airfoil, and the vertical distance from the lowest point of the lower surface of the intermediate airfoil to the forward most portion of the curved leading edge of the intermediate airfoil is less than 50% of the maximum airfoil thickness of the intermediate airfoil, more preferably between about 15% and 45% of the maximum airfoil thickness, and most preferably between about 25% and 35% of the maximum airfoil thickness.

Preferably, the intermediate airfoil has a maximum thickness defined by the maximum distance between an upper surface of the intermediate airfoil and a lower surface of the intermediate airfoil, and the radius of the curved leading edge of the intermediate airfoil is between about 15% and about 20% of the maximum thickness of the intermediate airfoil. The radius of the curved leading edge of the intermediate airfoil may be about 17% of the maximum thickness of the intermediate airfoil.

The intermediate airfoil preferably comprises a pair of upwardly extending members or projections at respective ends to assist in entraining airflow over the surface of the central portion of the intermediate airfoil.

Preferably, the intermediate airfoil has a maximum thickness defined by the maximum distance between an upper surface of the intermediate airfoil and a lower surface of the intermediate airfoil, and the members or projections extend above the trailing edge of the intermediate airfoil by about the maximum thickness of the intermediate airfoil.

Preferably, the intermediate airfoil has a chord defined by the distance from the leading edge of the intermediate airfoil to the trailing edge of the intermediate airfoil, and wherein the members or projections extend forwardly of the leading edge of the intermediate airfoil by about 5% of the chord of the intermediate airfoil.

Preferably, the intermediate airfoil has a maximum thickness defined by the maximum distance between an upper surface of the intermediate airfoil and a lower surface of the intermediate airfoil, and the intermediate airfoil is configured for attachment to the most forward bluff body so that its point of maximum thickness is located substantially directly above the trailing edge of the bluff body, and so that a gap is provided between the lower surface of the intermediate airfoil and the trailing edge of the bluff body.

In a preferred embodiment, the intermediate airfoil is configured for attachment at or adjacent the trailing edge of the most forward of the bluff bodies of the load such that the central portion has a positive effective angle of attack relative to oncoming airflow, to downwardly direct oncoming airflow. The effective angle of attack of the central portion of the intermediate airfoil may be about 2 degrees.

The intermediate airfoil preferably comprises an attachment arrangement for attaching the intermediate airfoil at or adjacent the trailing edge of the most forward of the bluff bodies of the load. The attachment arrangement for attaching the intermediate airfoil may comprise flanges configured to engage one or more surfaces of the most forward of the bluff bodies.

Alternatively, the attachment arrangement for attaching the intermediate airfoil may be configured to engage twist lock or cam lock sockets on a container. Preferably, the attachment arrangement for attaching the intermediate airfoil comprises spaced apart twist lock or cam lock pins configured for receipt in the twist lock or cam lock sockets. Alternatively, the attachment arrangement for attaching the intermediate airfoil may comprise a pair of substantially J-shaped connectors configured for receipt in complementary twist lock or cam lock sockets in the container and configured such that the airfoil must be tilted-to remove it from the container.

In accordance with a fourth aspect of the present invention, there is provided a leading edge airfoil as outlined in the first aspect above, when attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil.

In accordance with a fifth aspect of the present invention, there is provided a set of airfoils as outlined in the second aspect above, when the leading edge airfoil is attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil, and when the trailing edge airfoil is attached at or adjacent the trailing edge of the most rearward bluff body of the load being towed or carried by a truck.

In accordance with a sixth aspect of the present invention, there is provided a set of airfoils as outlined in the third aspect above, when the leading edge airfoil is attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil, and when the trailing edge airfoil is attached at or adjacent the trailing edge of the most rearward bluff body of the load being towed or carried by a truck, and when the intermediate airfoil is attached at or adjacent the trailing edge of the most forward bluff body of the load being towed or carried by a truck.

In accordance with a seventh aspect of the present invention, there is provided a truck towing or carrying at least one bluff body as a load, comprising a leading edge airfoil as outlined in the first aspect above attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, thereby reducing air drag.

In accordance with an eighth aspect of the present invention, there is provided a truck towing or carrying at least one bluff body as a load, comprising a set of airfoils as outlined in the second aspect above, with the leading edge airfoil attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, and with the trailing edge airfoil attached at or adjacent the trailing edge of the most rearward bluff body of the load, to reduce the area and volume of the load's turbulent flow, thereby reducing air drag.

In accordance with a ninth aspect of the present invention, there is provided a truck towing or carrying at least two bluff bodies as a load, comprising a set of airfoils as outlined in the third aspect above, with the leading edge airfoil attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, and with the trailing edge airfoil attached at or adjacent the trailing edge of the most rearward bluff body of the load, to reduce the area and volume of the load's turbulent flow, and with the intermediate airfoil attached at or adjacent the upper trailing edge of the most forward of the bluff bodies of the load and configured to direct airflow over the gap between the most forward bluff body and the following bluff body and toward the upper surface of the following bluff body, thereby reducing air drag.

Preferably, the truck comprises a tractor unit and “A” and “B” train trailers, and the intermediate airfoil is attached to the upper trailing edge of the “A” train trailer. The trailers may be curtain-sider trailers for example, or the airfoil could be attachable to a container.

Preferably, the truck comprises a tractor unit and “A” and “B” train trailers, and the leading edge airfoil is attached to the upper trailing edge of the “A” train trailer. The trailers may be curtain-sider trailers for example, or the airfoil could be attachable to a container.

The set of airfoils of the second or third aspect above may comprise attachment arrangement for attaching the airfoil(s) to the bluff body or bodies and configured such that the airfoil(s) can be interchanged between one bluff body and another.

In accordance with a tenth aspect of the present invention, there is provided a method of streamlining a truck carrying or towing one or more bluff bodies, comprising fitting a leading edge airfoil as outlined in the first aspect above to the most forward bluff body or tractor unit, or a set of airfoils as outlined in the second or third aspect above to one or more bluff bodies.

In one embodiment, the truck is loaded to tow or carry only a single bluff body and the method comprises fitting a leading edge airfoil as outlined in the first aspect above to the most forward bluff body or tractor unit such that the rear part of the upper surface of the airfoil is substantially aligned with the upper surface of the most forward bluff body with a space provided below the lower surface of the airfoil, and fitting a trailing edge airfoil of the set as outlined in the second or third aspect above at or adjacent the upper trailing edge of the bluff body.

In an alternative embodiment, the truck is loaded to tow or carry two bluff bodies and the method comprises fitting an airfoil as outlined in the first aspect above to the most forward bluff body or tractor unit such that the rear part of the upper surface of the airfoil is substantially aligned with the upper surface of the most forward bluff body and a space is provided below the lower surface of the airfoil, fitting an intermediate airfoil of the set as outlined in the third aspect above at or adjacent the upper trailing edge of the most forward bluff body, and fitting a trailing edge airfoil of the set as claimed in the second or third aspect above at or adjacent the upper trailing edge of the most rearward bluff body.

The invention consists in the foregoing and also envisages constructions of which the following gives examples only.

### BRIEF DESCRIPTION OF THE DRAWINGS

Preferred embodiments of the present invention will be described by way of example only with reference to the accompanying figures in which:

FIG. 1 is a schematic side elevation view of a tractor unit and “A” and “B” train trailers, indicating the primary areas contributing to overall drag;

FIG. 2 is a schematic side elevation view of the tractor unit and “A” and “B” train trailers, indicating high pressure regions;

FIG. 3 is a schematic plan view of the tractor unit and “A” and “B” train trailers of FIG. 1 when turning, or when the wind approaches the vehicle from a similar angle;

FIG. 4 shows a schematic side elevation view of the tractor unit and “A” and “B” train trailers fitted with airfoils in accordance with a preferred embodiment of the present invention;

FIG. 5a schematically shows the relative shape of a prior art leading edge deflector mounted on the front of an “A” train;

FIG. 5b schematically shows the relative shape of a preferred embodiment leading edge airfoil removably attached to an “A” train;

FIG. 6a shows a schematic side elevation view of a trailing edge airfoil mounted on a “B” train and the resulting airflow;

FIGS. 6b and 6c show schematic plan and rear views respectively of a preferred trailing edge airfoil;

FIG. 7a is a schematic side elevation view of the trailing edge drag cone for a tractor unit and “A” and “B” train trailers without airfoils;

FIG. 7b is a schematic side elevation view showing turbulent flow caused by a tractor unit and “A” and “B” train trailers with a tractor-mounted deflector only;

FIG. 7c is a schematic side elevation view of the trailing edge drag cone for a tractor unit and “A” and “B” train trailers with preferred embodiment airfoils attached;

FIG. 8a is a schematic side elevation view of the airflow over and behind a tractor unit (not shown) and “A” and “B” train trailers without airfoils;

FIG. 8b is a schematic side elevation view of the airflow over and behind a tractor unit (not shown) and “A” and “B” train trailers fitted with preferred embodiment airfoils;

FIG. 8c is a rear view of a rearmost bluff body showing the deposition pattern of road film which results from the use of the preferred embodiment airfoils;

FIG. 9 is a front view of the outer mould for forming the curved portion of a preferred embodiment leading edge stubnose airfoil;

FIG. 10 is a forward view of the mould of FIG. 9, showing its curvature;

FIG. 11a is a front overhead perspective view of the preferred stubnose airfoil showing an end plate;

FIG. 11b is a schematic side view or the airfoil of FIG. 11a;

FIG. 12 is a schematic perspective view showing the airfoil of FIGS. 9 to 11b attached to the leading edge of the forward bluff body;

FIG. 13 is a sectional view through the central part of the airfoil of FIGS. 9 to 12, showing its curvature and shape;

FIG. 14 is a left side elevation view of a mould of the central part of a preferred embodiment intermediate airfoil for directing air over the “A”-“B” train gap;

FIG. 15 is a view of an inner side of an end plate mould for the airfoil of FIG. 12;

FIG. 16 is a side view of a face plate mould for attachment to the outer side of an end plate such as shown in FIG. 15, with an end plate attached;

FIG. 17 is a sectional view through the central part of the airfoil of FIGS. 14 to 16, showing its shape and curvature;

FIG. 18 is a front view of a preferred embodiment trailing edge airfoil;

FIG. 19 is a front perspective view of one side of the airfoil of FIG. 18, showing one of the Homer tips;

FIG. 20 is a rear perspective view of the opposite side of the airfoil of FIG. 18, showing the other Homer tip;

FIG. 21 is a front sectional view of the airfoil of FIGS. 18 to 20, showing the interconnection of the tips to the central part;

FIG. 22 is a sectional view through the central part of the airfoil of FIGS. 18 to 21, showing its shape and curvature;

FIG. 23 shows a pair of support members being used to support the airfoil of FIGS. 18 to 22 on a bluff body;

FIG. 24 schematically shows an airfoil supported on a bluff body by the support members of FIG. 23;

FIG. 25 schematically shows the interconnection of an airfoil to a twist lock socket on a container using a twist lock pin; and

FIG. 26 schematically shows an alternative interconnection of the airfoil to a twist lock socket on a container.

### DETAILED DESCRIPTION OF PREFERRED FORMS

Wind tunnel testing shows typical bluff bodied vehicles to have a drag coefficient within the range of 0.8-1.3. Joined vehicles such as tractor and trailer units increase these typical figures.

The energy necessary to overcome tractive resistance for a moving truck can be conveniently divided into three areas; rolling resistance, acceleration (and climbing resistance), and air drag. At higher speeds, the proportion of tractive resistance expended on air drag becomes greater. As an example, a high bodied tractor unit/trailer combination weighing 38 tonnes requires 25 kW of power to overcome the air drag it generates at 60 km/hr. At higher speeds such as 100 km/hr, the energy required to overcome air drag increases to 70-75 kW. This energy is necessarily provided by the tractor unit and comes at the cost of increased fuel consumption.

The percentages of tractive resistance at highway speeds of 100 km/hr for a tractor unit towing “A” and “B” train trailers can be divided into the following:

| | |
|---|---|
| Rolling resistance | approximately 52% |
| Acceleration and climbing resistance | approximately 30% |
| Air drag | approximately 18% |

Typical fuel consumption to overcome the resistance to air drag on level roads at 72 km/hr is 35% of the total fuel used. This figure increases with road speed and may approach 38-40% at road speeds of 100-110 km/hr.

Airflow and its principal drag interactions over a tractor unit and its load can be seen as “formations” made up of the various sub-bodies which interact with each other. When the relative airflow is coming from directly in front of the truck, the partial drag of the entire body composed of the tractor unit and two trains following it can be divided up into the ratio of 4:3:2. When the gaps between the tractor unit and the “A” train, and/or between the “A” train and the “B” train increase, a slight increase in drag is observed.

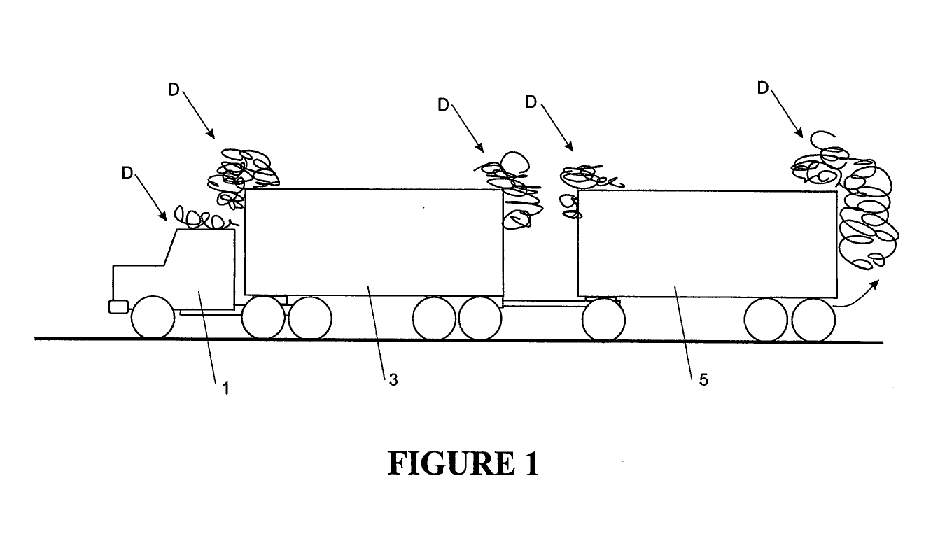

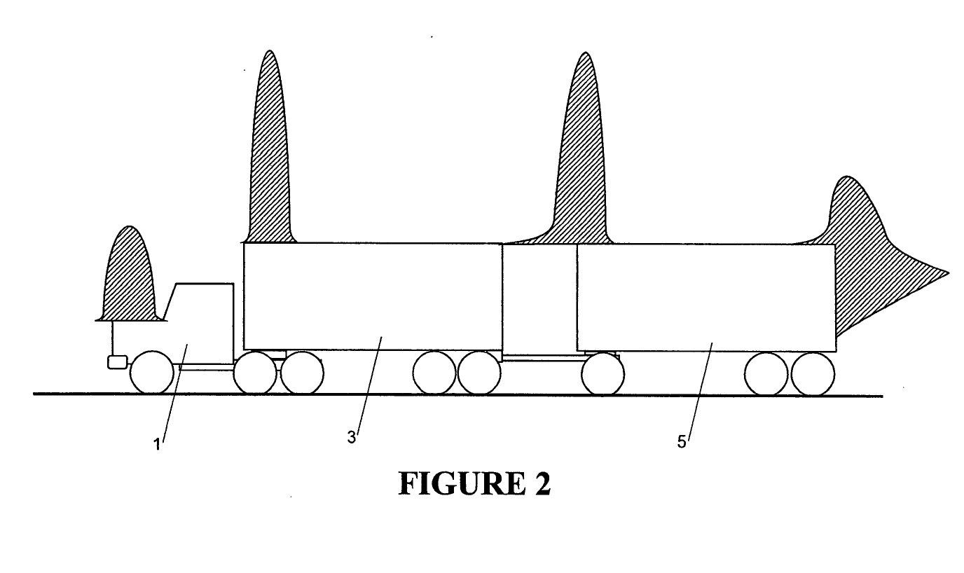

When traveling in a straight line such that the relative airflow approaches the tractor unit and trailer(s) from directly in front of the tractor unit, the areas which contribute to the overall drag are the roof of the tractor unit; the front edge, upper face and lip of the “A” train; the aft upper edge of the “A” train, the forward facing upper edge and panel of the “B” train, and the rearmost edge and rear (vertical) panel of the “B” train, as indicated schematically by the arrows D in FIG. 1, in which reference numeral 1 represents the cab or tractor unit, 3 is the “A” train, and 5 is the “B” train. The spirals represent turbulent flow. The hatched areas in FIG. 2 indicate the high pressure regions around the tractor unit and “A” and “B” trains.

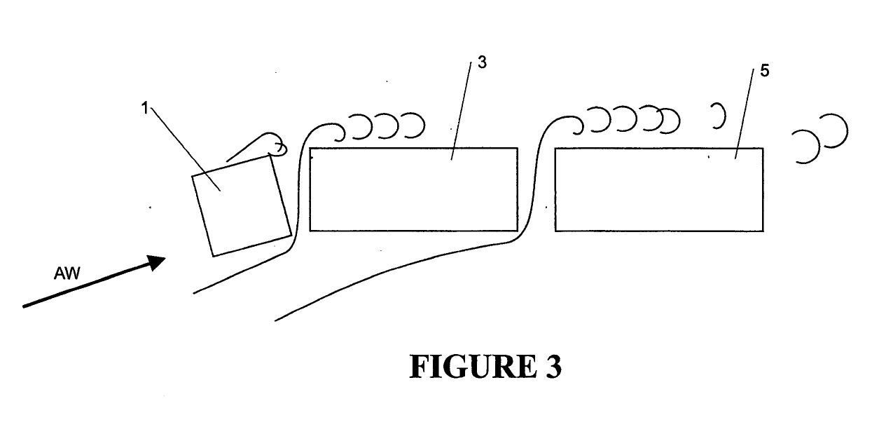

When turning or when driving in strong side winds such that the relative airflow approaches the vehicle from an angle, the drag coefficient of both of the “A” and “B” trains increases significantly, increasing the overall drag of the vehicle. This effect is principally due to the front panel of a container or curtain-sider trailer opening the gap between the tractor unit and the load train (and the gap between the “A” and “B” train if a “B” train is being towed). The opposing, or lee side, of the load also acts aerodynamically as the rear side of the vehicle relative to the airflow, and turbulent flow occurs in this area increasing drag as a result. This is indicated schematically in FIG. 3, in which arrow AW indicates the direction of the apparent wind or relative airflow due to the forward motion and turning of the tractor unit 1.

When the relative airflow is approaching from an angle due to the truck turning (ie operating in yaw), the tractor unit does not experience leeward separation flow as it is turning into the airflow. The tractor unit operates in positive pressure regimes irrespective of its angle to the apparent wind.

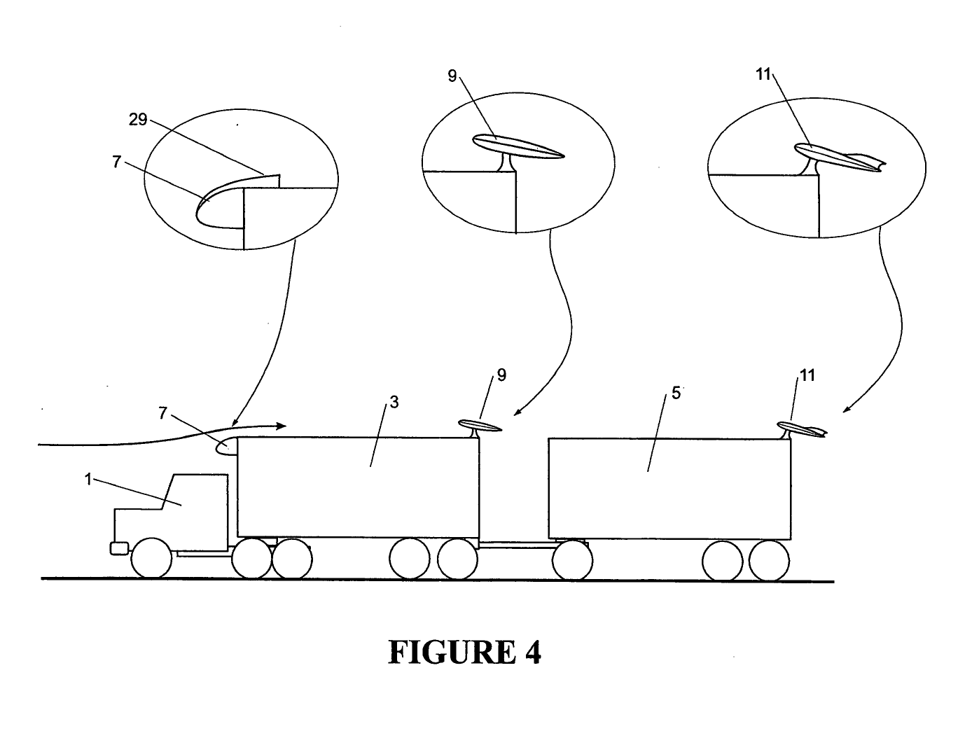

In accordance with a preferred embodiment of the present invention, a number of airfoils are attached to the “A” and “B” train in order to minimise drag. With reference to FIG. 4, three such airfoils are shown. A leading edge airfoil 7 is attached to the upper front edge of the “A” train 3, an intermediate airfoil 9 is attached to the upper rearward edge of the “A” train, and a trailing edge airfoil 11 is attached to the upper rearward edge of the “B” train 5. It should be appreciated that the airfoils are not shown to scale in this Figure. A deflector plate may or may not be attached to the roof of the tractor unit 1 to direct oncoming airflow to the leading edge airfoil 7, however such a deflector is not essential.

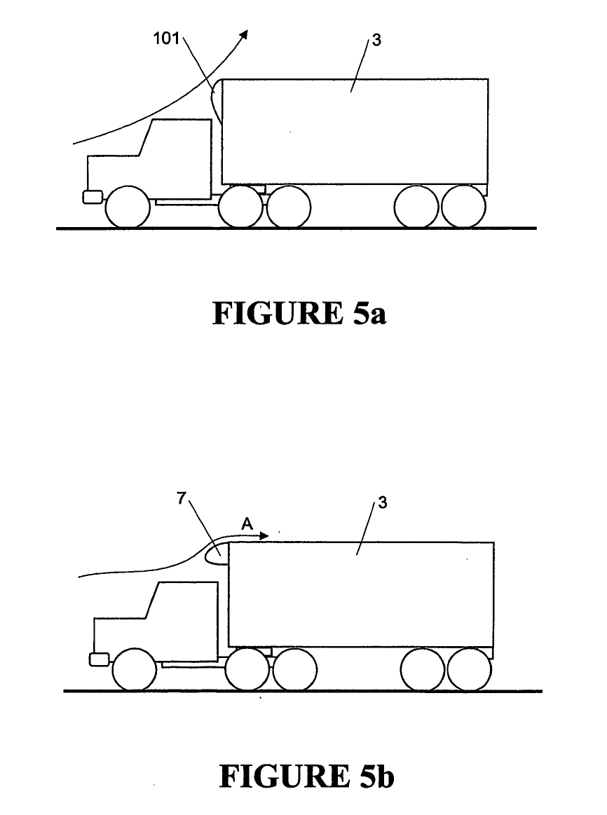

FIG. 5a shows the shape of a typical prior art leading edge curved deflector 101. It can be seen that the upper surface of the deflector 101 is relatively steep, which causes the approaching airflow A to be deflected away from the upper surface of the “A” train. The preferred leading edge airfoil 7 shown schematically in FIG. 5b is attached to the high pressure region of the “A” train. Rather than deflecting the approaching airflow A away from the upper surface of the “A” train, it can be seen that the preferred leading edge airfoil 7 assists in attaching the airflow to the upper surface of the “A” train.

Although only shown schematically in this Figure, it can be seen that the shape of the airfoil 7 is different to that of deflector 101. In particular, the leading edge airfoil is actually a stubnose part-airfoil (in that it has a curved leading edge, but does not terminate at a rearward tapered part), and can be seen to have a greater chord, and a less steep upper surface than the prior art deflector. The lower surface is also less steep than the lower surface of the prior art deflector. The airfoil has a curved nose and an upper surface angled away from the nose, and is preferably attached to the bluff body so that a rear part of the upper surface is substantially aligned with the upper surface of the bluff body. An alternative is that the airfoil could be attached to the tractor unit with the rear part of the upper leading surface substantially aligned with the upper surface of the bluff body.

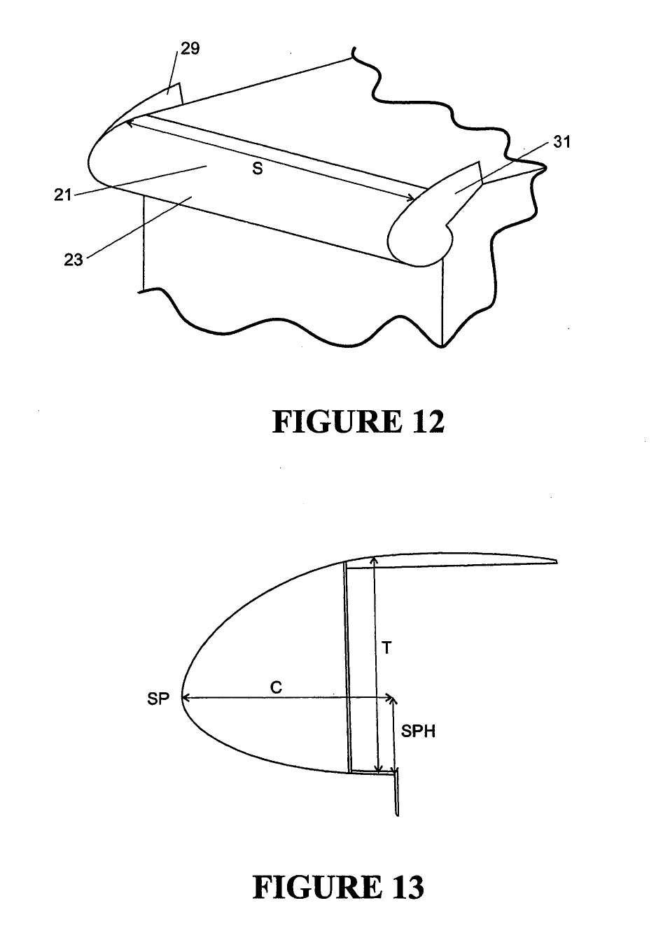

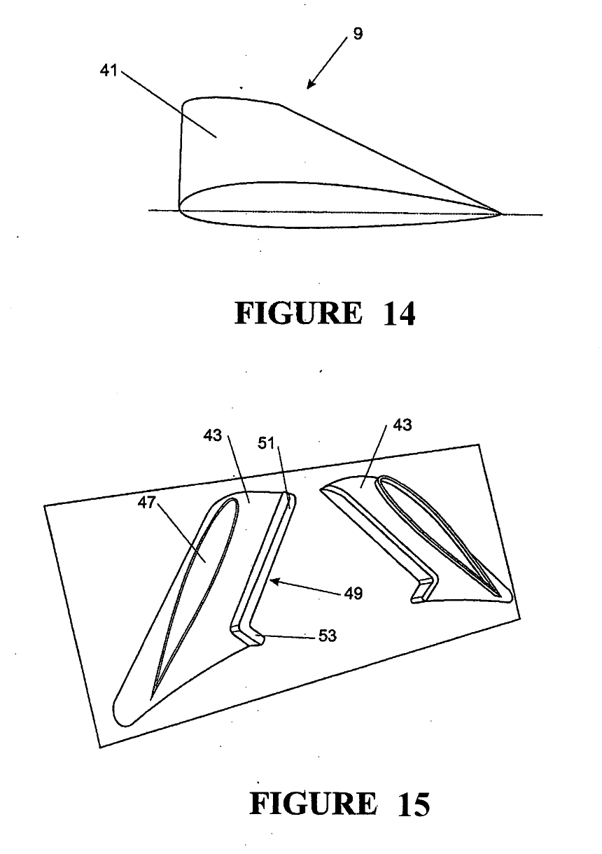

Factors which may contribute to performance include the curvature, stagnation point, length in relation to the bluff body (in this case the “A” train), aspect ratio, chord thickness ratio, and end plate design. At least some of these features, which are described in more detail below with reference to FIGS. 12 and 13, determine the form and reduced drag, as well as the resulting airflow behind the airfoil and the flow regimes in relation to the bluff body. The airfoil 7 produces lift and laminar flow, allowing the rearward flow to be nearer to the bluff body surface.

Reverting to FIG. 4, the intermediate airfoil 9 is arranged to reduce the drag gap between the “A” and “B” train by “grabbing” the air traveling along the upper surface of the “A” train and reducing the wake area. The airfoil 9 is arranged at a shallow positive angle of attack to the oncoming airflow from the upper surface of the “A” train, such as about 2 degrees. A positive angle of attack is one in which the leading edge of the airfoil is spaced a greater distance above the upper surface of the bluff body than the trailing edge. The angle of the airfoil is measured between the datum of the airfoil and the upper surface of the bluff body. The airfoil is preferably positioned so that the point of maximum lift (or camber), which in this embodiment is approximately 30% of the chord, is located directly above the sharp trailing edge of the “A” train. This airfoil acts to increase the speed of the airflow across the “A” and “B” train gap, and direct the airflow from the upper surface of the airfoil 9 toward the flat upper surface of the “B” train, negating or minimising the high pressure area which would normally exist. The angle of attack of the intermediate airfoil 9 may be variable to change the properties of the airflow if desired. Rather than having a generally symmetrical airfoil mounted with a desired angle of attack relative to the bluff body, the airfoil could be asymmetrical and designed such that the desired effective angle of attack is formed into the shape of the airfoil, as will be shown and described with reference to FIGS. 14 to 17.

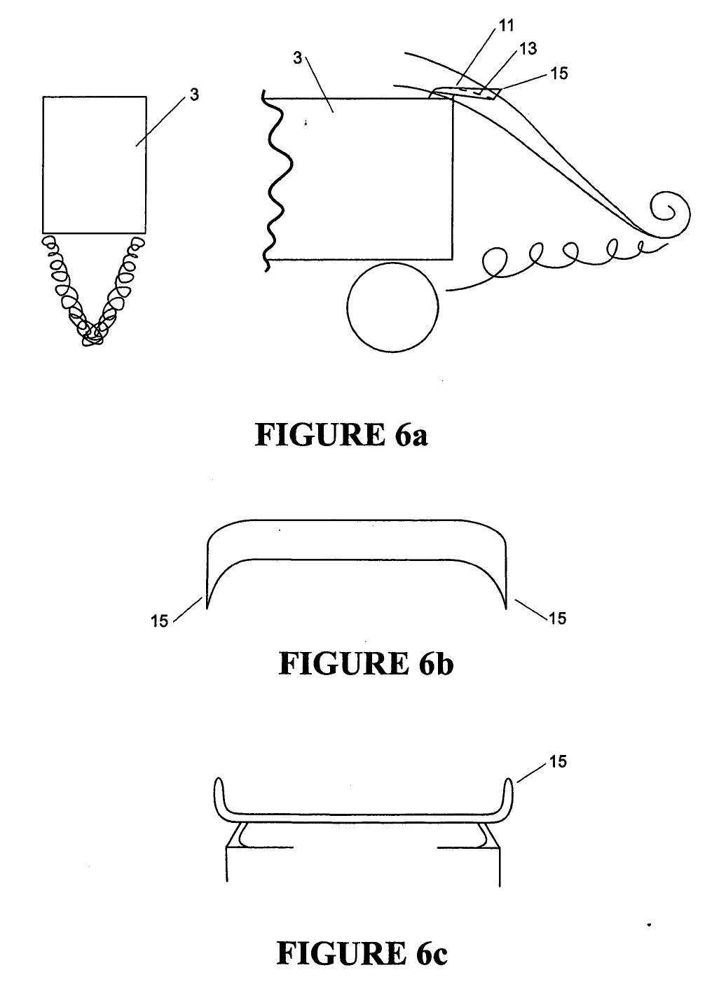

The trailing edge airfoil 11 may be mounted on the “B” train with a slightly more positive angle of attack (in other words, the datum of the airfoil is slightly more steep) than the intermediate airfoil 9 is mounted on the “A” train, to direct downwash so that the degree of turbulence and large area of drag normally associated with the rear of the bluff body is “boat-tailed”, reducing its area. The airflow behind the rear of the “B” train meets and mixes with the turbulent airflow from under the vehicle, further reducing drag, as indicated schematically in FIG. 6a.

A gap is suitably provided between the lower surface of each of the airfoils and the respective bluff bodies.

The trailing edge airfoil 11 includes a central airfoil portion 13 and end plates 15 (only one of which is visible) forming Horner tips which generate a rearward vortex from each side of the airfoil. The point of maximum thickness of the trailing edge airfoil is preferably located directly above the rear surface of the “B” train. When viewed from the rear of the “B” train, the left vortex spirals in a clockwise direction, and the right vortex spirals in an anticlockwise direction. The result of these vortices is that most of the drag is confined to a smaller area than it would be without the trailing edge airfoil 11. As the vortices travel rearwardly, they enlarge in diameter and impinge on each other, pulling the turbulent airstream which is exiting from the rear underside of the vehicle into a constant flow regime, and sweeping and rolling the airstreams together. The effect is that the area and volume of the vehicle's turbulent flow is reduced, thereby reducing drag.

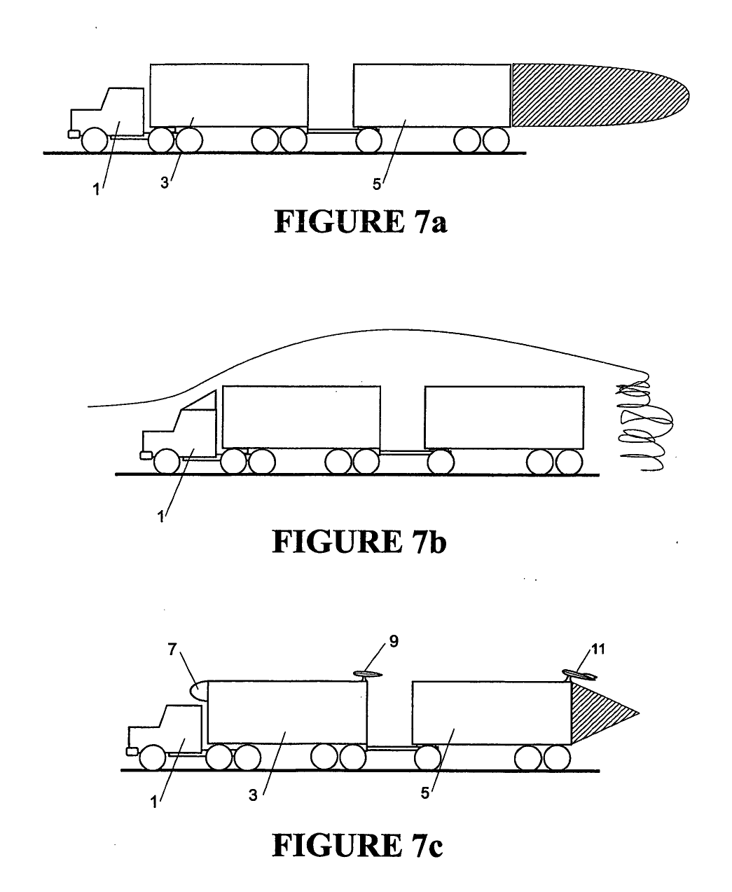

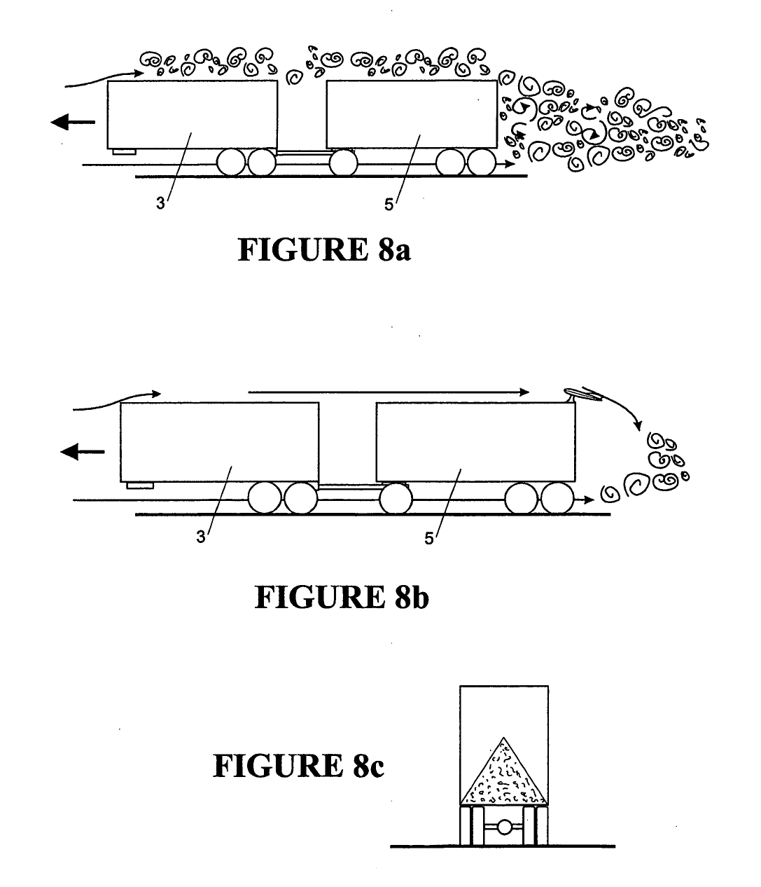

The relative sizes of the rearward drag cones (shown as hatched areas) from the vehicles with and without the trailing edge airfoils can be seen from FIG. 7, and it will be noted that the drag cone for the vehicle with the trailing edge airfoil is significantly smaller than that for the vehicle without a trailing edge airfoil.

Again, if desired, the angle of attack of the trailing edge airfoil may be adjustable.

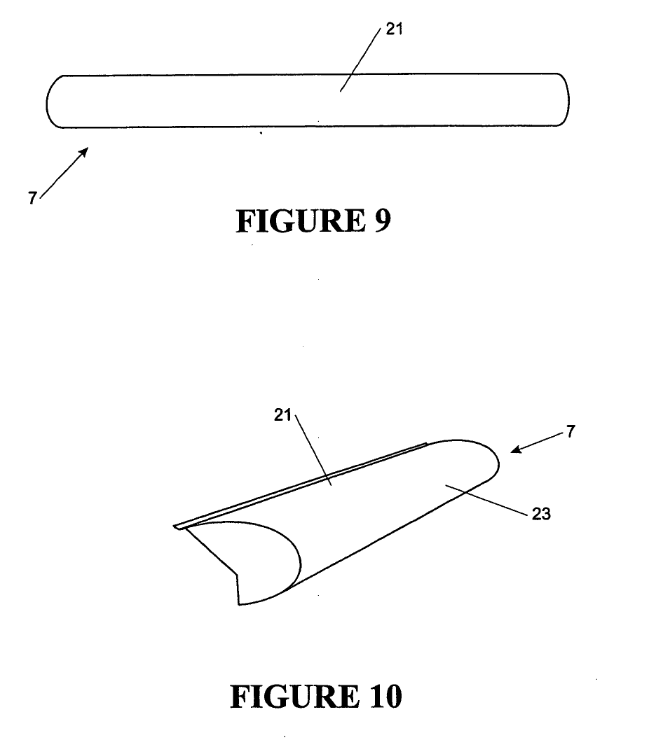

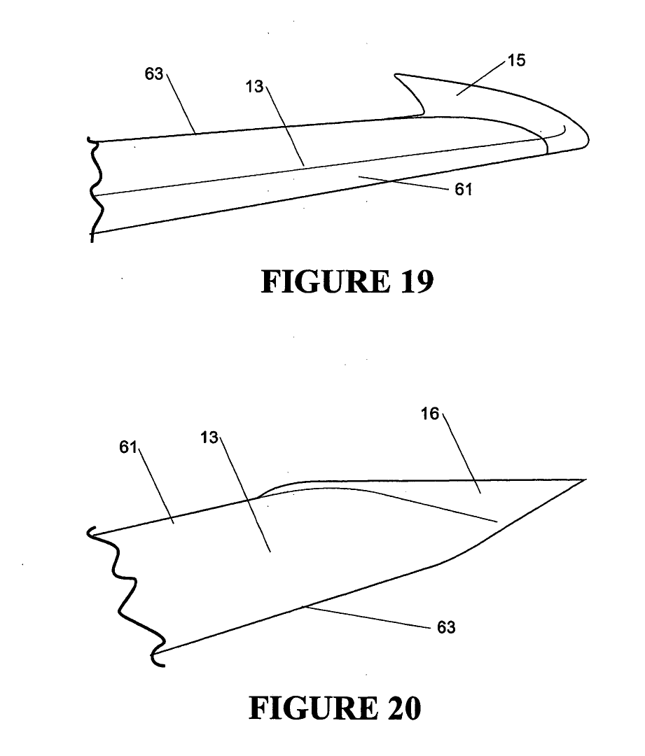

Preferred embodiment leading edge, intermediate, and trailing edge airfoils are shown in FIGS. 9-13, 14-17 and 18-22 respectively. It will be noted from the Figure descriptions that a number of the Figures show moulds. These moulds are generally covered by a suitable material such as glass fibre reinforced composite to form the final components. It should be noted that FIGS. 13, 17 and 22 show the airfoils the correct way up, i.e. in the orientations in which they would be attached in use.

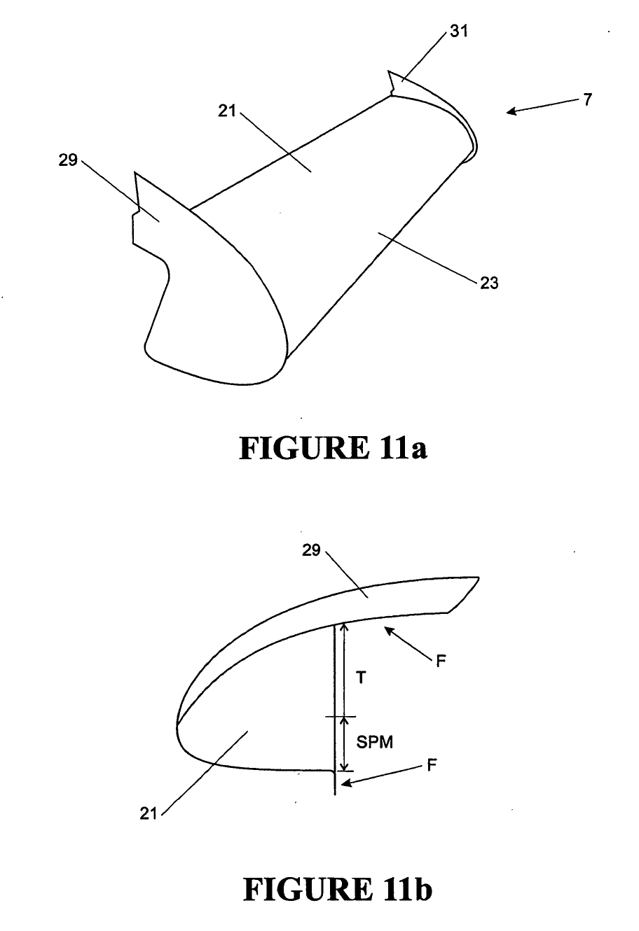

FIGS. 9 and 10 show a mould of the central portion of the leading edge stubnose airfoil shown in FIG. 11, showing the curvature of the surface. The leading edge stubnose part-airfoil 7 includes a central portion 21 having a curved leading surface 23. As shown in FIG. 11, end plates 29, 31 are attached to each end of the central portion 21. As shown, these endplates form upwardly-extending fins to entrain airflow over the surface of the airfoil in use. As can be seen from FIG. 11a and FIG. 11b, which shows a cross section of one end of the airfoil, the fins may start at the Phillips entry point or most forward curved part of the airfoil. Alternatively, the fins may extend around the underside of the airfoil. Also, as shown schematically in FIG. 11b, mounting flanges F are provided, one to attach the airfoil to the upper surface of the bluff body, the other to attach the airfoil to the forward surface of the bluff body.

It should be noted that the ratio of the Phillips entry, that being the vertical distance between the lower surface of the airfoil and the Phillips entry point (or stagnation point) vs the distance between the upper surface of the airfoil and the Phillips entry point (or stagnation point) is selected to obtain optimum aerodynamic properties.

FIG. 12 schematically shows the preferred embodiment front airfoil mounted on a bluff body, and FIG. 13 shows a cross sectional view of the central portion of the airfoil. It can be seen that the airfoil is a part section airfoil. The preferred airfoil has a span S (measured between the insides of the end plates) to chord C ratio (known as the aspect ratio) of between about 7:1 and 9:1, and a chord C to thickness T ratio of between about 1.1:1 and 1.4:1. The height SPH of the stagnation point SP is generally between about 22% and 33% of the thickness T. The radius of the nose (in the vicinity of the stagnation point SP) of the airfoil is preferably about 40% of the chord C of the airfoil. The upper forward surface above the stagnation point SP preferably has a smooth surface finish, with a maximum surface roughness of about 1 mm. It can be seen that the lower surface has a generally flatter profile than the upper surface. These parameters, and the relatively bluff body below the airfoil, induce a stagnant flow below the airfoil, and induce laminar flow over the airfoil. The laminar flow entrains air and pulls it down towards the upper surface of the bluff body. The vertical end plates “fence” the airflow at the extreme ends of the airfoil, which reduces turbulence. Without the plates, there would normally be turbulence at the tip section of the airfoil. The airfoil reduces drag caused by the leading edge of the bluff body, which can amount to 25% of the total vehicle drag.

The airfoil is preferably mounted on the bluff body with an approximately zero degree angle of incidence to the oncoming airflow. However, due to the low position of the stagnation point, and the greater curvature and distance over the upper surface than the lower surface, the airfoil preferably effectively has a positive angle of attack to the oncoming air (ie is equivalent to an airfoil having its nose higher than its trailing edge).

As mentioned above, the airfoil preferably includes end plates 29, 31 which form aerodynamic fins or fences to entrain airflow. The end plate fins extend above the trailing edge of the airfoil as shown in FIG. 12. In the embodiment in which the airfoils are provided as a set, it is preferred that the fins extend above the trailing edge of the leading edge airfoil by about the maximum thickness of the intermediate airfoil described below. The end plates project forwardly of the airfoil and above the leading edge/stagnation point SP by about 5% of the chord of the airfoil. The end plates preferably include mounting flanges so that they act as stands to support the airfoil on the bluff body.

As shown in FIG. 14, the intermediate airfoil 9 includes a central portion 41 having a curved leading surface and a relatively sharp trailing edge. The airfoil also includes end plates 43, 45 one of which is shown in FIG. 15. The right end plate 45 shown in the Figures would be located on the right side of the vehicle when the intermediate airfoil 9 is mounted on the rear of the “A” train, and a left end plate would be located on the left side of the vehicle. The end plate 45 has a lower flange 49 having a base portion 51 which rests against the upper surface of the “A” train when the airfoil is installed, and a rear portion 53 which locates against the back wall of the “A” train when installed. A socket 47 is provided on the inside of each end plate for receipt of a respective end of the central portion 41 of the airfoil 9. Although not shown in these figures, the intermediate airfoil could be mounted such that its angle of attack is variable.

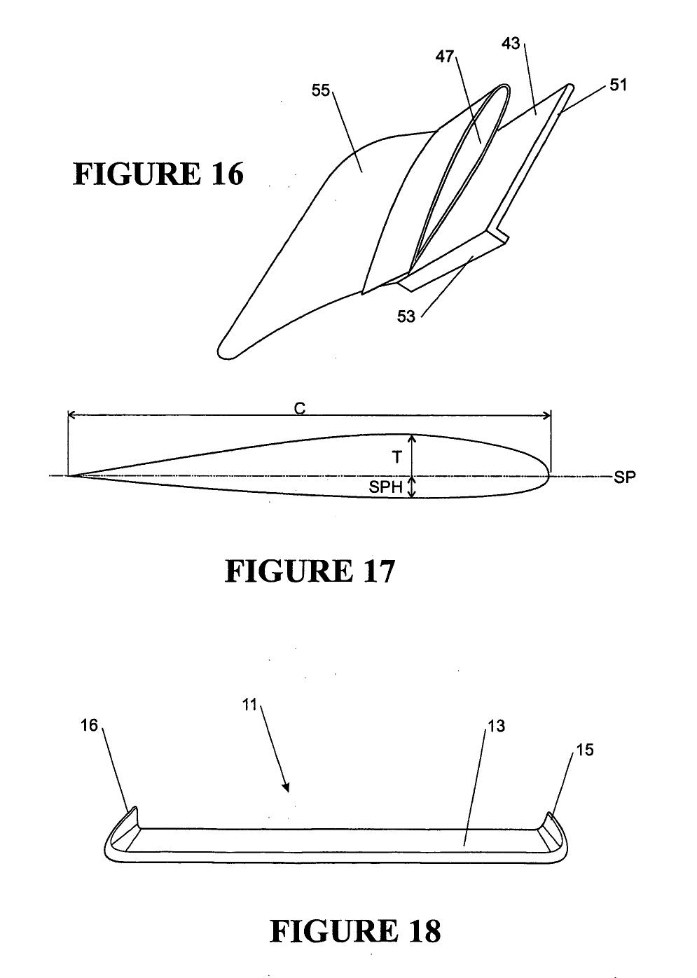

As shown in FIG. 16, a face plate 55 is attached to the outer surface of the end plate 43. The face plate 55 has an upper vertical plate section, which extends above the airfoil central portion 41 when attached to the end plate 43. The purpose of the upper vertical plate section is to direct airflow over the central portion 41 of the airfoil. The face plate 55 is a manufacturing convenience, and the upper vertical plate sections could be provided as part of the end plates 43, 45 if desired, or could be unitary with the airfoil central portion.

The curvature of the central portion of the preferred intermediate airfoil is shown in FIG. 17. The preferred aspect ratio (span to chord ratio) is between about 5.5:1 and about 6:1, and more preferably about 5.8:1. The size of the maximum thickness T is preferably between about 8.1% and 13.5% of the size of the chord. More preferably, the size of the maximum thickness T is preferably about 13% of the size of the chord. The point of maximum camber MC (camber being a median line between the upper surface and lower surface) is preferably between about 30 and 35% of the chord, and more preferably about 32.8% of the chord, measured from the front of the airfoil. The stagnation point height SPH is preferably less than 50% of the thickness T measured from the base, more preferably between about 15% and 45% of the thickness T, and most preferably between about 25% and 35% of the thickness T. The nose radius is preferably between about 15% and about 20% of the thickness T, and more preferably about 17% of the thickness T.

As shown, the central portion of the airfoil is asymmetric, and is shaped such that it has an effective positive angle of attack relative to the oncoming airflow. That is, while the airfoil is preferably mounted such that the datum from the leading edge to the trailing edge of the central portion is substantially horizontal, the airfoil has the lift characteristics of a symmetrical airfoil having a datum at an angle to the horizontal. The effective angle of attack is preferably a positive angle of attack of about 2 degrees; that is an angle of attack equivalent to a symmetrical airfoil having a datum angled downwards by about 2 degrees towards the rear of the airfoil.

As mentioned above, the airfoil preferably includes face plates and end plates which form aerodynamic fins or fences to entrain airflow. The fins extend above the trailing edge of the airfoil, preferably by about the maximum thickness T of the airfoil. The plates project forwardly of the airfoil and above the leading edge/stagnation point SP by about 5% of the chord of the airfoil. The plates preferably include mounting flanges so that they act as stands to support the airfoil on the bluff body.

As shown in FIGS. 18-22, the trailing edge airfoil 11 includes a central portion 13 and a pair of rearwardly-extending vortex generating Homer tips 15, 16. The central portion has a curved front edge 61 and a relatively sharp rear edge 63. It can be seen that the airfoil is of relatively low cross-sectional profile. The purpose of the vortex generating end tips and the airfoil has been described above.

The curvature of the central portion of the preferred trailing edge airfoil is shown in FIG. 22. The preferred aspect ratio (span to chord ratio) is between about 3.75:1 and about 4.25: 1, and more preferably about 4.1:1. The size of the maximum thickness T is preferably between about 8.1% and 13.5% of the size of the chord. More preferably, the size of the maximum thickness T is preferably about 13.2% of the size of the chord. The point of maximum camber MC is between about 37.5% and 42.5% of the chord, and more preferably about 39.5% of the chord (measured from the front of the airfoil). The stagnation point height SPH is preferably between about 35% and about 40% of the thickness T measured from the base, and more preferably about 36% of the thickness T. The nose radius is preferably between about 30% and about 35% of the thickness T, and more preferably about 33.3% of the maximum thickness T.

The Homer tips 15, 16 preferably extend behind the trailing edge of the airfoil by about 25% of its chord. The rise of each tip 15, 16 directly above the point of maximum thickness is preferably about 14% of the maximum thickness.

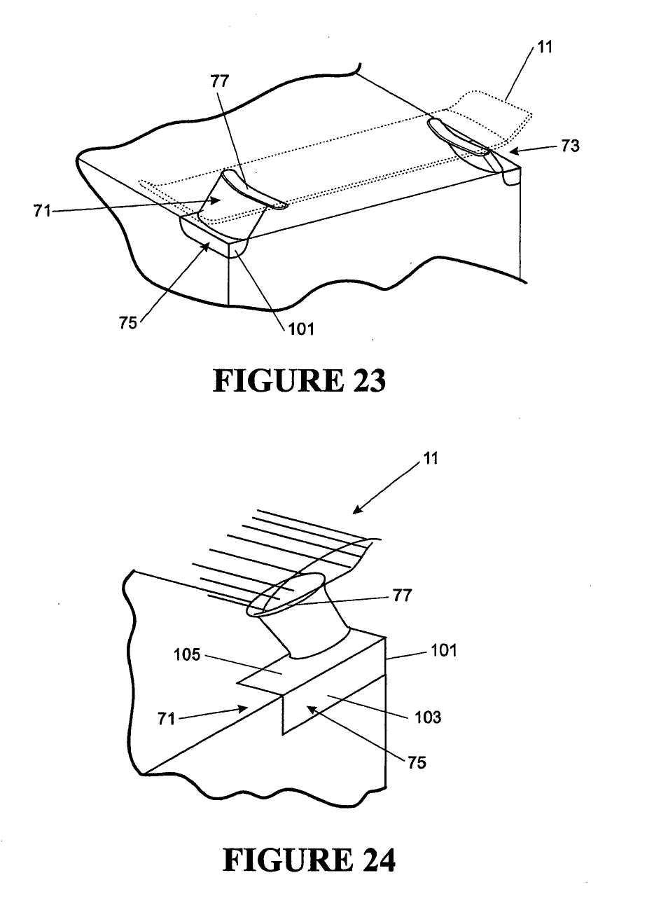

One form of support members 71, 73 for mounting the airfoil 11 on the trailing edge of a “B” train are shown in FIGS. 23 and 24. With reference to the left support member 71 shown in the Figures, the support member 71 includes a mounting part 75 for mounting the support member 71 on the rear left corner of the “B” train, and a shaped upper surface or saddle 77 upon which the airfoil 11 is mounted. As shown in FIG. 24, the mounting part 75 includes an upper flange 105, a rear flange 101 and a side flange 103. When attached to the “B” train, these flanges will be located against respective surfaces of the “B” train. In a preferred embodiment, the support members 71, 73 may be provided integrally with the airfoil 11. Although not shown in the figures, if desired the trailing edge airfoil 11 may be mounted so that its angle of attack is adjustable.

All of the airfoils may be provided in two or more pieces so that they may be easily sized as necessary to incorporate bluff bodies of differing widths. In particular, the airfoils may be provided as an elongate piece including for example a fitting, end plate, and the full airfoil blade, and a cap piece including for example a fitting and end plate. The elongate piece can then be cut to the required length to accommodate the width of the particular bluff body, and then inserted into a socket on the cap end. In the case of the trailing edge airfoil 11, this could be provided with the cap end having a support member and one of the Horner tips.

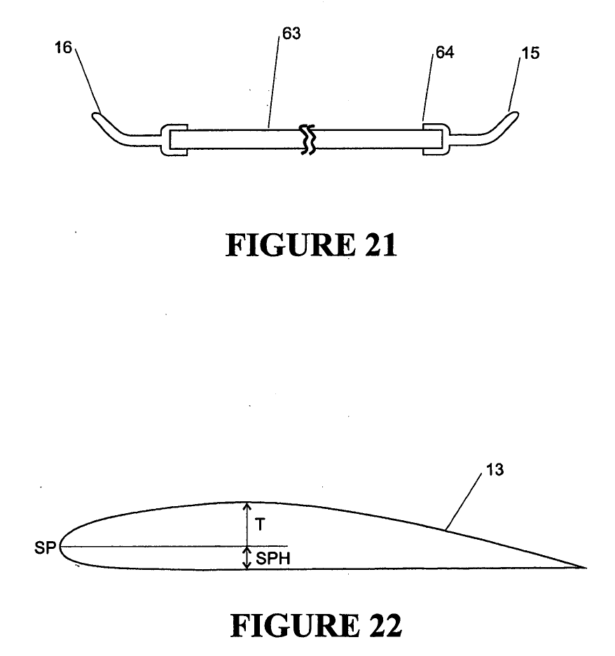

As shown schematically in FIG. 21 for example, the trailing edge airfoil has seams 64 defined by sockets separating the end portions (and fins) from the central portion. This enables the central portion to be cut to length, and slotted in to the end portions to suit trucks of various widths.

The airfoils may be semi-permanently or permanently attached to the bluff bodies by an attachment arrangement, for example with fasteners such as bolts, rivets, adhesives, etc (or combinations of the above), or more preferably are detachably attached to the bluff bodies by the attachment arrangement so that they can easily be attached to different loads. For example, the airfoils may be attachable to trailers or containers through the use of cam lock or twist lock type mechanisms. Preferably, a pair of spaced apart cam lock or twist lock pins or lugs extend downwardly from the airfoils, and are receivable in complementary generally oblong cam lock or twist lock sockets at the corners of containers. Standard containers have such twist lock sockets, which are conventionally used to fasten the container to one placed on top of it. If necessary, tie-down straps may be used to provide extra stability to the installed airfoils. It is preferred that the airfoils are attached to the upper surfaces of the bluff bodies. It may be desirable however for mounting brackets to attach to both the tops and sides of the bluff bodies, to provide additional tension to the airfoils.

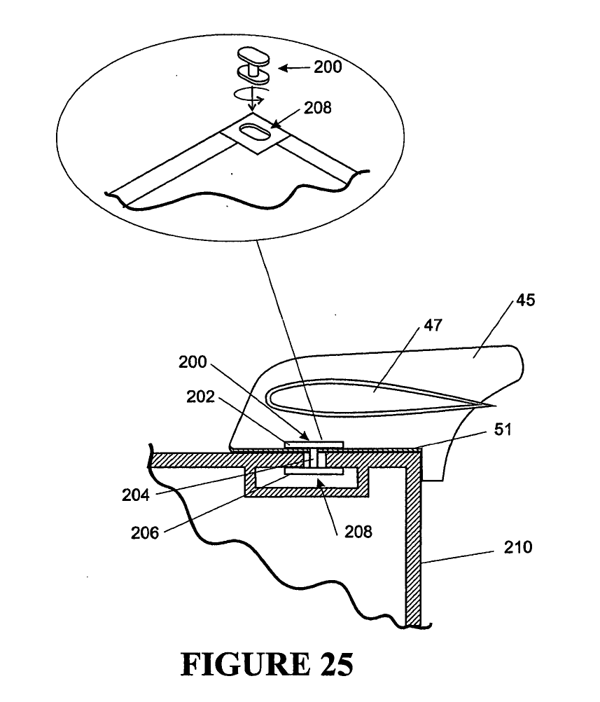

FIG. 25 shows an end plate 45 of an attachment arrangement for use in mounting an intermediate airfoil to a container. The end plate includes a socket 47 for receipt of a central part of the airfoil. Mounted through an aperture in the lower flange 51 of the end plate 45 is a twist lock pin 200 having a head 202, shaft 204, and an elongate engagement part 206. In use, the end plate 45 (and attached airfoil) is placed on the container, with the twist lock pin 200 positioned so that the long part of the elongate attachment part 206 is aligned with the long part of the twist lock socket 208 of the container 210. Once the elongate attachment part is within the socket, the head 202 is turned which causes the elongate attachment part 206 of the pin 200 to turn inside the socket 208, thereby attaching the airfoil to the container. It will be appreciated that the same arrangement will be provided at the other end of the container. To remove the airfoil from the container, the pin 200 is turned so that the long part of the elongate attachment part 206 is again aligned with the long part of the twist lock socket 208, so that the pin can be removed from the socket. A similar configuration could also be used to attach the leading or trailing airfoils to respective containers.

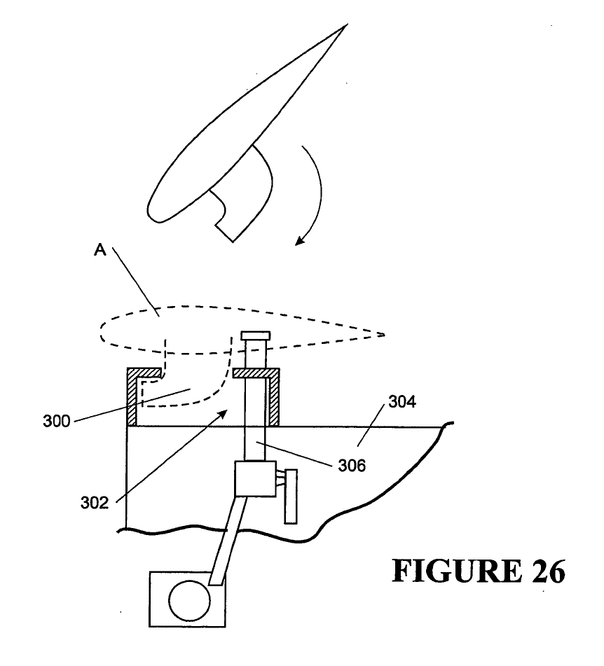

An alternative attachment arrangement for attaching the airfoils to twist lock sockets in containers is shown in FIG. 26. A pair of spaced apart substantially J-shaped connectors 300 (only one of which is shown in the Figure) extend downwardly from the airfoil A, and are sized and spaced for receipt in respective twist lock sockets 302 of a container 304. To mount the airfoil A on the container 304, the airfoil is tilted forwardly so that the lower ends of the connectors 300 are directed toward the twist lock sockets 302. After the ends of the connectors 300 have been inserted into their respective sockets 302, the airfoil is tilted rearwardly to the position shown in FIG. 27. The connectors are shaped such that the airfoil cannot be removed from the sockets without tilting it forwardly. To prevent forward tilting, straps or ratchet tie downs 306 are used to connect a rearward part of the airfoil to a lower part of the container as shown.

Any of the airfoils could be connected using the methods described above.

For reference, standard container dimensions are as follows:

| | External Container Dimensions (mm) | | |
|---|---|---|---|
| | Length | Height | Width |
| 20 ft container | 6,058 | 2,591 | 2,438 |
| 40 ft container | 12,192 | 2,326 | 2,438 |
| 40 ft hi-cube | 12,192 | 2,895 | 2,438 |

The airfoils will generally extend substantially the full width of the bluff body to which they are attached. In the embodiment in which the mounting brackets attach to the sides of the bluff bodies, it is anticipated that they will need to extend approximately 12 mm to each side. The maximum heights of the leading edge, intermediate and trailing edge airfoils above the top surfaces of the respective bluff bodies are preferably about 90 mm, 160 mm and 170 mm respectively.

It is preferred that the airfoils and mounting members will be made from polymer or composite materials, to provide strength and low weight. The preferred material is a polyester impregnated glass fibre composite material with a gel coating to provide a smooth aerodynamically efficient surface.

If a lightweight material is used to make the airfoils, the airfoils will be relatively light and can be easily stored behind the tractor when not in use and maintained in position by the tie downs. When needed, they could easily be lifted into position using a pole or similar, and then maintained in position on the bluff body/bodies with the tie downs.

The airfoils could be attached to curtain-sider trailers during their manufacture. Alternatively, they may be provided as an aftermarket fitting, either alone or in sets or kits. For a truck carrying or towing a single bluff body, the set preferably includes a leading edge airfoil and a trailing edge airfoil as described above. For a truck carrying or towing two bluff bodies, the set preferably includes a leading edge airfoil, an intermediate airfoil, and a trailing edge airfoil as described above. The sets may also include all required mounting members, fasteners, etc.

Testing has shown that on a varying route, a tractor towing an “A” and “B” train has achieved a fuel saving of about 18.4% using the preferred embodiment airfoils. An even greater saving should be possible over a line haul route where the vehicle can be driven more towards maximum legal speed, due to the exponential increase in drag with speed. It is estimated that about 74% of the reducable drag is being reduced through the use of these airfoils. On a flat road at constant highway speeds, a further 26% drag reduction may be achievable, which would result in a total fuel saving of about 23.18% under ideal conditions.

The above describes preferred embodiments of the present invention, and modifications may be made thereto without departing from the scope of the invention.

For example, while the above preferred embodiment shows a truck comprising a tractor unit towing an “A” train and a “B” train, the devices may be used on a truck towing only an “A” train. The airfoil directing air across the “A” and “B” train gap would not be used in such an embodiment, but the rearward vortex generator could be provided at the rear edge of the “A” train. Further, a leading edge airfoil and a trailing edge airfoil could be used on a truck having a single bluff body such as a tray mounted container or a non-trailer curtain-sider for example.

While the above preferred embodiment shows a tractor unit towing “A” and “B” trains, the principle of the invention could be extended to trucks towing further bluff bodies, such as “C”, “D” trains as would be found on Australian “road trains”.

Rather than the leading edge stubnose airfoil being attached to the forward bluff body, it could be attached to or mounted on top of the tractor unit. This would be particularly suitable when the bluff body does not move (turn) relative to the tractor unit when the truck is in motion, such as a tractor unit with a tray-mounted container or an integral curtain-sider covered tray. Such a variant could also be used when the bluff body is trailer mounted, but it is expected that the performance would not be as satisfactory, especially when the truck is turning. However, such a configuration may be suitable for a truck which generally does long distance runs on relatively straight roads.

The preferred devices described above provide a number of benefits.

Rather than simply addressing the frontal drag on the tractor unit and its load, the above devices assist in minimising drag in the primary drag-inducing areas of the loaded vehicle.

The devices described above assist in containing the envelope maintaining the airflow in close proximity to the vehicle and its attached load. They address aspects of aerodynamic drag in each section of the vehicle and its load. The airfoils entrain and shape the entire flow regime so as to minimise the three main contributors to drag in a vehicle towing an “A” and “B” train. The devices reduce the size of the highest pressure area, that being the highest point of the leading edge of the “A” train. They also improve airflow across the gap between the rearward portion of the “A” train and the leading edge of the “B” train, as well as addressing the width, area and volume of the turbulent area located behind the rearmost section of the “B” train. The flow wake is redirected and reduced in area both above and to the sides of the vehicle and load. The flows react about the centreline of the vehicle. The reduction in volume and frontal area of total displaced flow minimise its impact on other road users.

The above trailing edge airfoils, by virtue of having “Homer” tips or fins minimise or prevent outer eddy turbulence, and assist in entraining airflow over the inner surfaces of the airfoils.

Further, in wet conditions a reduction in spray area results, enhancing safety by providing a wider angle of view for both the truck driver to the rear and for other road users in passing situations.

The reduction in drag results in a reduction in horsepower and therefore fuel consumption required to overcome it.

It is estimated that under idealized flow, with the air flow approaching the vehicle from directly ahead of the vehicle, drag reductions of up to 57% are achievable, and it is expected that using the airfoils described herein as well as reducing weight could assist in achieving fuel savings of up to 40%.

The airfoils are preferably attachable and detachable from the trailer(s) or container(s), meaning that a user is able to purchase one such set of airfoils for use with different loads. The airfoils may be attachable to a container without interference with the containers' swinging doors or the container truck's swing loading apparatus.

The airfoils also offer a slight drag reduction when airflow approaches the vehicle at an angle (ie when driving in crosswinds or when turning). However, long haul routes will show the greatest grains from the use of the aerodynamic devices.

Other safety benefits which may result from the use of the preferred airfoils include:

improved tracking ability, resulting in less trailer sway in overtaking manoeuvres;

shorter overtaking time, due to greater acceleration by aerodynamic drag reduction;

a lowering of rearward amplification, as the degree to which the trailing units amplify or exaggerate the lateral motions of the tractor unit is reduced by the aerodynamic coupling between the “A” and “B” train and the vortices induced at the rear of the last component of the train. As the forces generated by the combination of the three airfoils act in two planes, and with the larger of the three forces acting behind and on the centerline of the vehicle, the “righting” effect acts on the towed train;

improved braking in a straight path, due to inducement and direction of the flow from the rear vortex generators, the drag becomes centred on the centerline of the vehicle. Without such vortex generators, the rearmost trailer unit can move over a greater arc within the wide zone of turbulence caused by the bluff rear panel before it meets the relative laminar airstream generated by the forward motion of the vehicle;

safer lane changing at highway speeds, as the aerodynamic devices exert their effect on the airstream at an angle but parallel with the span (across and parallel with the roof of the vehicle), thereby exerting a righting couple which counters any sudden changes to the flow regime of the towed train;

yaw damping. Oscillations imposed on the vehicle and its train as a result of road undulations are damped by the airfoils, and decay rates are therefore of a shorter duration than for vehicles without attached airfoils;

minimisation of high speed transient off-tracking caused by sudden evasive manoeuvres, as greater aerodynamic forces are imposed as vehicle speed increases; and

a lowering of driver fatigue, due to the improvements in tracking ability, resulting in less driver exertion and resulting tiredness.

It should be appreciated that not all of the advantages or benefits outlined above necessarily apply to every embodiment.

1. A leading edge airfoil for reducing drag on a truck towing or carrying at least one bluff body as a load, the airfoil comprising a curved nose and an upper surface angled away from the curved nose and a lower surface extending rearwardly from the curved nose, with the vertical distance from a lowest point of the lower surface to a most forward part of the curved nose being less than the vertical distance from an upper point of the upper surface to the most forward part of the curved nose, the airfoil configured for attachment to a most forward bluff body of the load or to the top of a tractor unit with a rear part of the upper surface substantially aligned with an upper surface of the most forward bluff body of the load and with a space provided below the lower surface of the airfoil, such that the airfoil assists in attaching oncoming airflow to the upper surface of the most forward bluff body, thereby reducing air drag.

2. A leading edge airfoil as claimed in claim 1, wherein the airfoil is configured for attachment to a forward surface of the most forward bluff body.

3. A leading edge airfoil as claimed in claim 1, wherein the airfoil is configured to produce lift and laminar flow, thereby assisting in attaching oncoming airflow to the upper surface of the bluff body in use.

4. A leading edge airfoil as claimed in claim 1, wherein the airfoil has a span defined by a width of the airfoil and a chord defined by the distance from the most forward part of the nose to a trailing edge, and wherein the ratio of airfoil span to airfoil chord is between about 7:1 and about 9:1.

5. A leading edge airfoil as claimed in claim 1, wherein the airfoil has a chord defined by the distance from the most forward part of the nose to a trailing edge and a maximum thickness defined by the maximum distance between the upper surface and the lower surface, and wherein the ratio of airfoil chord to maximum airfoil thickness is between about 1.1:1 and about 1.4:1.

6. A leading edge airfoil as claimed in claim 1, wherein the lower surface is angled away from the curved nose.

7. A leading edge airfoil as claimed in claim 6, wherein the upper surface generally extends rearwardly from the nose with a greater angle than the lower surface.

8. A leading edge airfoil as claimed in claim 6, wherein the airfoil has a maximum thickness defined by the maximum distance between the upper surface and the lower surface, and wherein the vertical distance from the lowest point of the lower surface to the most forward part of the curved nose is between about 22% and 33% of the maximum thickness.

9. A leading edge airfoil as claimed in claim 1, wherein the airfoil has a chord defined by the distance from the most forward part of the nose to a trailing edge and the radius of the nose is about 40% of the airfoil chord.

10. A leading edge airfoil as claimed in claim 1, comprising end plates or fins extending upwardly from respective ends of the airfoil, which end plates or fins are arranged to assist in entraining air flow over the airfoil in use.

11. A leading edge airfoil as claimed in claim 10, wherein the end plates or fins extend rearwardly and above an upper rear edge of the airfoil.

12. A leading edge airfoil as claimed in claim 1, comprising an attachment arrangement for attaching the airfoil to the most forward bluff body.

13. A leading edge airfoil as claimed in claim 12, wherein the attachment arrangement comprises flanges configured to engage one or more surfaces of the most forward bluff body.

14. A leading edge airfoil as claimed in claim 12, wherein the attachment arrangement is configured to engage twist lock or cam lock sockets on a container.

15. A leading edge airfoil as claimed in claim 14, wherein the attachment arrangement comprises spaced apart twist lock or cam lock pins configured for receipt in the twist lock or cam lock sockets.

16. A leading edge airfoil as claimed in claim 14, wherein the attachment arrangement comprises substantially J-shaped connectors configured for receipt in complementary twist lock or cam lock sockets in the container and configured such that the airfoil must be tilted to remove it from the container.

17. A set of airfoils for reducing drag on a truck towing or carrying at least one bluff body as a load, comprising a leading edge airfoil as claimed in claim 1 and a trailing edge airfoil which is configured for attachment at or adjacent a trailing edge of a most rearward bluff body of the load, and which is configured to reduce the area and volume of the load's turbulent flow in use, thereby reducing air drag.

18. A set of airfoils as claimed in claim 17, wherein the trailing edge airfoil has a central portion with a curved leading edge and a relatively sharp trailing edge.

19. A set of airfoils as claimed in claim 18, wherein the trailing edge airfoil has a span defined by a width of the trailing edge airfoil and a chord defined by the distance from the leading edge of the trailing edge airfoil to the trailing edge of the trailing edge airfoil, and wherein the ratio of airfoil span of the trailing edge airfoil to airfoil chord of the trailing edge airfoil is between about 3.75:1 and about 4.25:1.

20. A set of airfoils as claimed in claim 18, wherein the trailing edge airfoil has a chord defined by the distance from the leading edge of the trailing edge airfoil to the trailing edge of the trailing edge airfoil and a maximum thickness defined by the maximum distance between an upper surface of the trailing edge airfoil and a lower surface of the trailing edge airfoil, and wherein the size of the maximum thickness of the trailing edge airfoil is between about 8.1% and 13.5% of the size of the chord of the trailing edge airfoil.

21. A set of airfoils as claimed in claim 18, wherein the trailing edge airfoil has a maximum thickness defined by the maximum distance between an upper surface of the trailing edge airfoil and a lower surface of the trailing edge airfoil, and wherein the vertical distance from the lowest point of the lower surface of the trailing edge airfoil to a forward most portion of the curved leading edge of the trailing edge airfoil is between about 35% and 40% of the maximum airfoil thickness of the trailing edge airfoil.

22. A set of airfoils as claimed in claim 18, wherein the trailing edge airfoil has a maximum thickness defined by the maximum distance between an upper surface of the trailing edge airfoil and a lower surface of the trailing edge airfoil, and wherein the radius of the curved leading edge of the trailing edge airfoil is between about 30% and about 35% of the maximum thickness of the trailing edge airfoil.

23. A set of airfoils as claimed in claim 17, wherein the trailing edge airfoil comprises at least one vortex generating projection to induce a rearward vortex in use.

24. A set of airfoils as claimed in claim 23, wherein the trailing edge airfoil comprises a pair of vortex generating tips at the ends of the airfoil.

25. A set of airfoils as claimed in claim 24, wherein the tips of the trailing edge airfoil extend rearwardly, the tips being arranged so that in use two vortices of opposite sense are generated, confining drag to a smaller area.

26. A set of airfoils as claimed in claim 25, wherein the tips of the trailing edge airfoil are arranged so that in use, as the vortices travel rearwardly they enlarge in diameter and impinge on each other, pulling turbulent airstream which is exiting from the underside of the vehicle into a substantially constant flow regime.

27. A set of airfoils as claimed in claim 24, configured such that the tips of the trailing edge airfoil extend upwardly when the trailing edge airfoil is attached to the bluff body.

28. A set of airfoils as claimed in claim 27, wherein the trailing edge airfoil has a chord defined by the distance from a leading edge of the trailing edge airfoil to a trailing edge of the trailing edge airfoil, and wherein the tips extend rearwardly of the trailing edge of the trailing edge airfoil by about 25% of the chord of the trailing edge airfoil.

29. A set of airfoils as claimed in claim 28, wherein the trailing edge airfoil has a maximum thickness defined by the maximum distance between an upper surface of the trailing edge airfoil and a lower surface of the trailing edge airfoil, and wherein the rise of each tip directly above the point of maximum thickness of the trailing edge airfoil is about 14% of the maximum thickness of the trailing edge airfoil.

30. A set of airfoils as claimed in claim 17, wherein the trailing edge airfoil has a point of maximum lift, and wherein the trailing edge airfoil is configured for attachment to the most rearward bluff body so that its point of maximum lift is located substantially directly above the trailing edge of the bluff body, and so that a gap is provided between a lower surface of the trailing edge airfoil and the trailing edge of the bluff body.

31. A set of airfoils as claimed in claim 17, wherein the trailing edge airfoil is configured for attachment at or adjacent the trailing edge of the most rearward bluff body of the load with a positive angle of attack relative to oncoming airflow, to downwardly direct oncoming airflow.

32. A set of airfoils as claimed in claim 17, including an attachment arrangement for attaching the trailing edge airfoil at or adjacent the trailing edge of the most rearward bluff body of the load.

33. A set of airfoils as claimed in claim 32, wherein the attachment arrangement for attaching the trailing edge airfoil comprises flanges configured to engage one or more surfaces of the most rearward bluff body.

34. A set of airfoils as claimed in claim 32, wherein the attachment arrangement for attaching the trailing edge airfoil is configured to engage twist lock or cam lock sockets on a container.

35. A set of airfoils as claimed in claim 34, wherein the attachment arrangement for attaching the trialing edge airfoil comprises spaced apart twist lock or cam lock pins configured for receipt in the twist lock or cam lock sockets.

36. A set of airfoils as claimed in claim 34, wherein the attachment arrangement for attaching the trailing edge airfoil comprises substantially J-shaped connectors configured for receipt in complementary twist lock or cam lock sockets in the container and configured such that the trailing edge airfoil must be tilted to remove it from the container.

37. A set of airfoils as claimed in claim 17 for reducing drag on a truck towing or carrying at least two bluff bodies as a load, comprising an intermediate airfoil which is configured for attachment at or adjacent an upper trailing edge of the most forward of the bluff bodies of the load, and which is configured in use to direct airflow over the gap between the most forward bluff body and a following bluff body and toward the upper surface of the following bluff body in use, thereby reducing air drag.

38. A set of airfoils as claimed in claim 37, wherein the intermediate airfoil has a central portion with a curved leading edge and a relatively sharp trailing edge.

39. A set of airfoils as claimed in claim 38, wherein the intermediate airfoil has a span defined by a width of the intermediate airfoil and a chord defined by the distance from the leading edge of the intermediate airfoil to the trailing edge of the intermediate airfoil, and wherein the ratio of airfoil span of the intermediate airfoil to airfoil chord of the intermediate airfoil is between about 5.5:1 and about 6:1.

40. A set of airfoils as claimed in claim 38, wherein the intermediate airfoil has a chord defined by the distance from the leading edge of the intermediate airfoil to the trailing edge of the intermediate airfoil and a maximum thickness defined by the maximum distance between an upper surface of the intermediate airfoil and a lower surface of the intermediate airfoil, and wherein the size of the maximum thickness of the intermediate airfoil is between about 8.1% and about 13.5% of the size of the chord of the intermediate airfoil.

41. A set of airfoils as claimed in claim 38, wherein the intermediate airfoil has a maximum thickness defined by the maximum distance between an upper surface of the intermediate airfoil and a lower surface of the intermediate airfoil, and wherein the vertical distance from the lowest point of the lower surface of the intermediate airfoil to the forward most portion of the curved leading edge of the intermediate airfoil is less than 50% of the maximum airfoil thickness of the intermediate airfoil.

42. A set of airfoils as claimed in claim 41, wherein the vertical distance from the lowest point of the lower surface of the intermediate airfoil to the forward most portion of the curved leading edge of the intermediate airfoil is between about 15% and 45% of the maximum airfoil thickness of the intermediate airfoil.

43. A set of airfoils as claimed in claim 42, wherein the vertical distance from the lowest point of the lower surface of the intermediate airfoil to the forward most portion of the curved leading edge of the intermediate airfoil is between about 25% and 35% of the maximum airfoil thickness of the intermediate airfoil.

44. A set of airfoils as claimed in claim 38, wherein the intermediate airfoil has a maximum thickness defined by the maximum distance between an upper surface of the intermediate airfoil and a lower surface of the intermediate airfoil, and wherein the radius of the curved leading edge of the intermediate airfoil is between about 15% and about 20% of the maximum thickness of the intermediate airfoil.

45. A set of airfoils as claimed in claim 38, wherein the intermediate airfoil comprises a pair of upwardly extending members or projections at respective ends to assist in entraining airflow over the surface of the central portion of the intermediate airfoil.

46. A set of airfoils as claimed in claim 45, wherein the intermediate airfoil has a maximum thickness defined by the maximum distance between an upper surface of the intermediate airfoil and a lower surface of the intermediate airfoil, and wherein the members or projections extend above the trailing edge of the intermediate airfoil by about the maximum thickness of the intermediate airfoil.

47. A set of airfoils as claimed in claim 45, wherein the intermediate airfoil has a chord defined by the distance from the leading edge of the intermediate airfoil to the trailing edge of the intermediate airfoil, and wherein the members or projections extend forwardly of the leading edge of the intermediate airfoil by about 5% of the chord of the intermediate airfoil.

48. A set of airfoils as claimed in claim 37, wherein the intermediate airfoil has a maximum thickness defined by the maximum distance between an upper surface of the intermediate and a lower surface of the intermediate airfoil, and wherein the intermediate airfoil is configured for attachment to the most forward bluff body so that its point of maximum thickness is located substantially directly above the trailing edge of the bluff body, and so that a gap is provided between the lower surface of the intermediate airfoil and the trailing edge of the bluff body.

49. A set of airfoils as claimed in claim 38, wherein the intermediate airfoil is configured for attachment at or adjacent the trailing edge of the most forward of the bluff bodies of the load such that the central portion of the intermediate airfoil has a positive effective angle of attack relative to oncoming airflow, to downwardly direct oncoming airflow.

50. A set of airfoils as claimed in claim 49, wherein the effective angle of attack of the central portion of the intermediate airfoil is about 2 degrees.

51. A set of airfoils as claimed in claim 37, comprising an attachment arrangement for attaching the intermediate airfoil at or adjacent the trailing edge of the most forward of the bluff bodies of the load.

52. A set of airfoils as claimed in claim 51, wherein the attachment arrangement for attaching the intermediate airfoil comprises flanges configured to engage one or more surfaces of the most forward of the bluff bodies.

53. A set of airfoils as claimed in claim 51, wherein the attachment arrangement for attaching the intermediate airfoil is configured to engage twist lock or cam lock sockets on a container.

54. A set of airfoils as claimed in claim 53, wherein the attachment arrangement for attaching the intermediate airfoil comprises spaced apart twist lock or cam lock pins configured for receipt in the twist lock or cam lock sockets.

55. A set of airfoils as claimed in claim 53, wherein the attachment arrangement for attaching the intermediate airfoil comprises a pair of substantially J-shaped connectors configured for receipt in complementary twist lock or cam lock sockets in the container and configured such that the airfoil must be tilted to remove it from the container.

56. A leading edge airfoil as claimed in claim 1, when attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil.

57. A set of airfoils as claimed in claim 17, when the leading edge airfoil is attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil, and when the trailing edge airfoil is attached at or adjacent the trailing edge of the most rearward bluff body of the load being towed or carried by a truck.

58. A set of airfoils as claimed in claim 37, when the leading edge airfoil is attached to the most forward bluff body of a load being towed or carried by a truck, or when attached to the top of the tractor unit, such that a rear part of the upper surface is substantially aligned with an upper surface of the most forward bluff body and a space is provided below the lower surface of the airfoil, and when the trailing edge airfoil is attached at or adjacent the trailing edge of the most rearward bluff body of the load being towed or carried by a truck, and when the intermediate airfoil is attached at or adjacent the trailing edge of the most forward bluff body of the load being towed or carried by a truck.

59. A truck towing or carrying at least one bluff body as a load, comprising a leading edge airfoil as claimed in claim 1 attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, thereby reducing air drag.

60. A truck towing or carrying at least one bluff body as a load, comprising a set of airfoils as claimed in claim 17, with the leading edge airfoil attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, and with the trailing edge airfoil attached at or adjacent the trailing edge of the most rearward bluff body of the load, to reduce the area and volume of the load's turbulent flow, thereby reducing air drag.

61. A truck towing or carrying at least two bluff bodies as a load, comprising a set of airfoils as claimed in claim 37, with the leading edge airfoil attached to the most forward bluff body of the load or to the top of a tractor unit, with the upper surface of the airfoil substantially aligned with an upper surface of the most forward bluff body of the load and with a space provided below the lower surface of the airfoil, to assist in attaching oncoming airflow to the upper surface of the most forward bluff body, and with the trailing edge airfoil attached at or adjacent the trailing edge of the most rearward bluff body of the load, to reduce the area and volume of the load's turbulent flow, and with the intermediate airfoil attached at or adjacent the upper trailing edge of the most forward of the bluff bodies of the load and configured to direct airflow over the gap between the most forward bluff body and the following bluff body and toward the upper surface of the following bluff body, thereby reducing air drag.

62. A set of airfoils as claimed in claim 17, comprising an attachment arrangement for attaching the airfoil(s) to the bluff body or bodies and configured such that the airfoil(s) can be interchanged between one bluff body and another.

63. A method of streamlining a truck carrying or towing one or more bluff bodies, comprising fitting a leading edge airfoil as claimed in claim 1 to the most forward bluff body or tractor unit, or a set of airfoils as claimed in claim 17 to one or more bluff bodies.

64. A method of streamlining a truck as claimed in claim 63, wherein the truck is loaded to tow or carry only a single bluff body and the method comprises fitting the leading edge airfoil to the most forward bluff body or tractor unit such that the rear part of the upper surface of the airfoil is substantially aligned with an upper surface of the most forward bluff body and a space is provided below a lower surface of the airfoil, and fitting a trailing edge airfoil of the set of airfoils at or adjacent an upper trailing edge of the bluff body.

65. A method of streamlining a truck as claimed in claim 64, wherein the truck is loaded to tow or carry two bluff bodies and the method comprises fitting the leading edge airfoil to the most forward bluff body or tractor unit such that a rear part of the upper surface of the airfoil is substantially aligned with an upper surface of the most forward bluff body and a space is provided below a lower surface of the airfoil, fitting an intermediate airfoil of the set which is configured for attachment at or adjacent an upper trailing edge of the most forward of the bluff bodies of the load, and which is configured in use to direct airflow over a gap between the most forward bluff body and the following bluff body and toward an upper surface of the following bluff body in use, at or adjacent the upper trailing edge of the most forward bluff body, and fitting the trailing edge airfoil of the set of airfoils at or adjacent the upper trailing edge of the most rearward bluff body.
